(19) United States
(12) Patent Application Publication
(10) Pub. No.: US 2012/0324403 A1
(43) Pub. Date: Dec. 20, 2012

(54) METHOD OF INFERRING NAVIGATIONAL INTENT IN GESTURAL INPUT SYSTEMS

(76) Inventors: Adriaan Van De Ven, Portland, OR (US); Aras Bilgen, Hillsboro, OR (US)

(21) Appl. No.: 13/160,626

(22) Filed: Jun. 15, 2011

(51) Int. Cl. G06F 3/01

(52) U.S. Cl. 715/863

(57) ABSTRACT

In a processing system having a touch screen display, a method of inferring navigational intent by a user in a gestural input system of the processing system is disclosed. A graphical user interface may receive current gestural input data for an application of the processing system from the touch screen display. The graphical user interface may generate an output action based at least in part on an analysis of one or more of the current gestural input data, past gestural input data for the application, and current and past context information of usage of the processing system. The graphical user interface may cause performance of the output action.

### FIELD

The present disclosure generally relates to the field of graphical user interfaces (GUIs) in processing systems. More particularly, an embodiment of the invention relates to inferring navigational intent of a user's gestural inputs in a GUI of a processing system.

### BACKGROUND

Processing systems with touch and gesture-based user interfaces do not have pointing mechanisms that are as precise as those found on systems with mice or pen input devices. In the absence of such absolute pointing devices, the user cannot interact with the graphical user interface (GUI) parts with the same accuracy. This limitation creates a situation that directly impacts the users' ability to carry on fundamental navigation tasks with high precision, such as scrolling, panning, and moving objects on the screen.

Other significant factors contribute to this imprecision. First, the sensor system on the processing system might not have a high accuracy to ensure smooth gesture detection. Second, the user might have physiological limitations that would interfere with smooth gesture detection, such as trembling hands, irregular shaped fingers, or arthritis. Third, the user might have environmental limitations that interfere with smooth gesture detection, such as traveling on public transportation or using the device in extreme outdoor conditions.

There are two current solutions to the imprecise scrolling problem. The first solution is to make the scrolling/navigating user interface (UI) widget larger. For example, an application may show a particular type of a scrollbar in one application, and show another, optimized scrollbar in another application. An example of this approach is used in some media players on mobile processing systems. The scrollbar that allows the user to select a location in a movie, for example, has higher precision than a scrollbar in a web browser due to its larger size.

The second solution is to keep the UI widget the same but provide filtering options for the content. Filters limit the content visible on the screen, thereby increasing the precision of the scrolling/navigating mechanism by limiting the options that the user sees. For example, address book applications on mobile processing systems provide this optimization by allowing the user to pick a contacts group and showing only those entries.

The current solutions either force the user to learn to use new controls or limit the content the user sees on the screen. A better solution to gesture recognition is desired.

### BRIEF DESCRIPTION OF THE DRAWINGS

The detailed description is provided with reference to the accompanying figures. The use of the same reference numbers in different figures indicates similar or identical items.

FIG. 1 is a diagram of a processing system according to an embodiment of the present invention.

FIG. 2 is a flow diagram of gesture recognition processing according to an embodiment of the present invention.

FIG. 3 is a diagram of a user input control component according to an embodiment of the present invention.

FIG. 4 is a flow diagram of user input control processing according to an embodiment of the present invention.

FIGS. 5 and 6 illustrate block diagrams of embodiments of processing systems, which may be utilized to implement some embodiments discussed herein.

### DETAILED DESCRIPTION

Embodiments of the present invention overcome deficiencies in existing processing systems relating to gesture detection and processing. Embodiments of the present invention increase the accuracy of user input data when the user is scrolling through linear, planar or spatial user interfaces using fingers, hands, infrared (IR) remotes or other types of gestural input methods. This optimization is done by learning the navigation behavior based on spatial inputs of the user and inferring the user's current navigational intent based on the past behavior. Embodiments of the present invention adapt the output action resulting from detecting a gestural input based at least in part on the currently detected gestural input data, past gestural input data for the current application, and the current and past context of the processing system when similar gestural input data has been recognized.

Embodiments of the present invention allow the user to keep in view all display content without having to rely on specialized UI widgets. This optimization decreases the learning curve for using the processing system since the user does not need to learn to use two different controls for scrolling, for example. Moreover, because the content is not filtered, the user can stay in the same context to perform his or her task more quickly and with less cognitive load.

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention. Further, various aspects of embodiments of the invention may be performed using various means, such as integrated semiconductor circuits (“hardware”), computer-readable instructions organized into one or more programs stored on a computer readable storage medium (“software”), or some combination of hardware and software. For the purposes of this disclosure reference to “logic” shall mean either hardware, software (including for example micro-code that controls the operations of a processor), firmware, or some combination thereof.

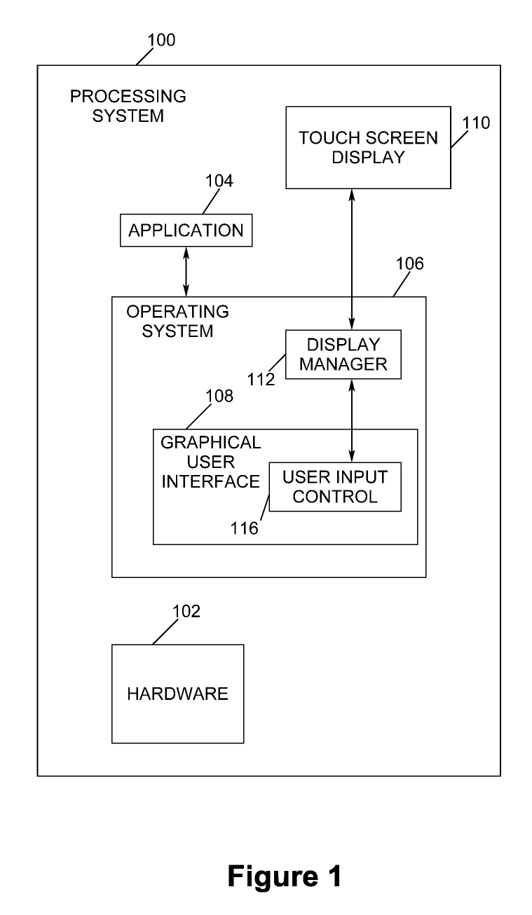

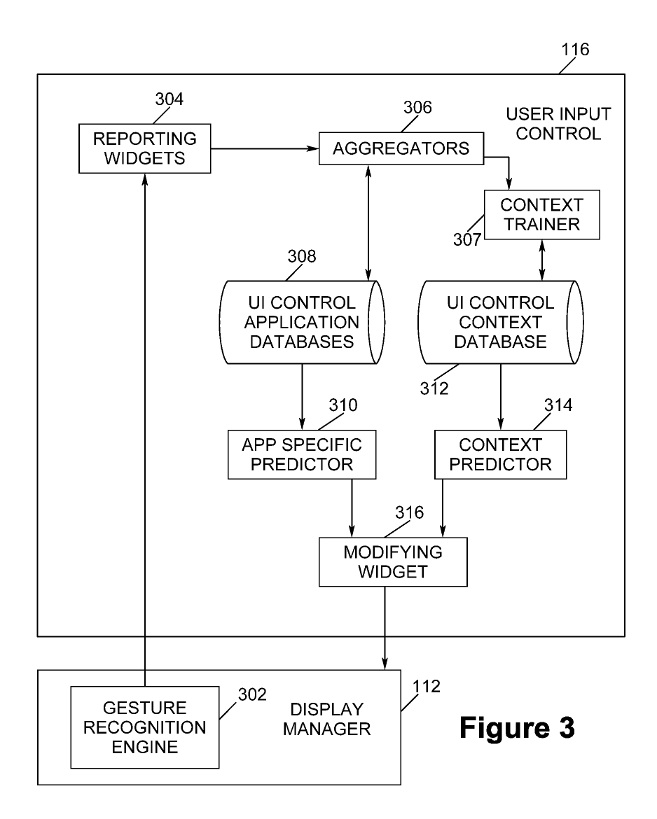

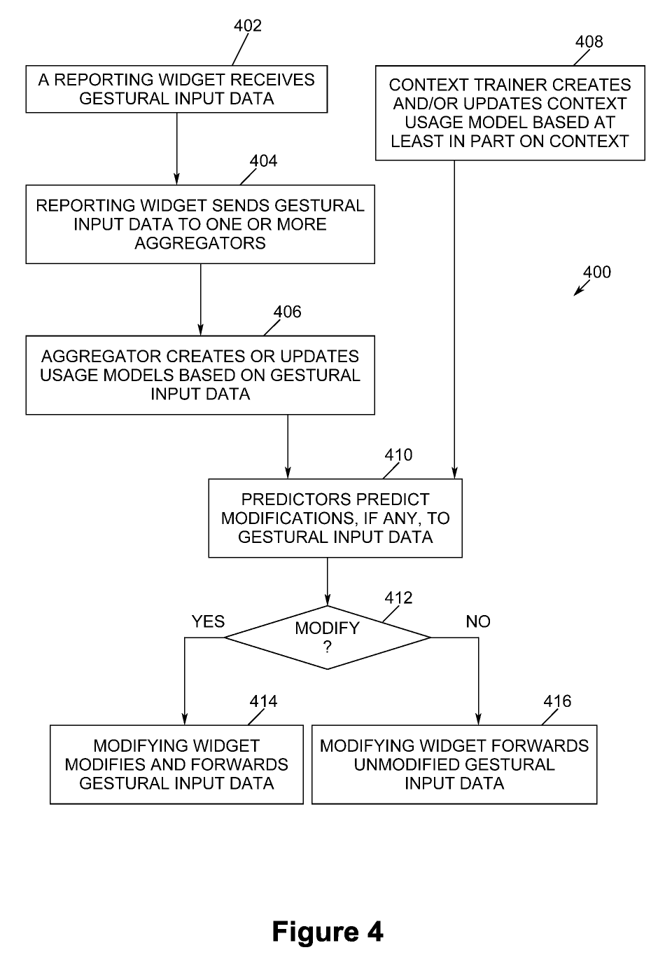

FIG. 1 is a diagram of a processing system according to an embodiment of the present invention. In various embodiments, processing system 100 may be a smart phone, a personal computer (PC), a laptop computer, a netbook, a tablet computer, a handheld computer, a mobile Internet device (MID), or any other stationary or mobile processing device. As shown in the simplified diagram of FIG. 1, processing system 100 comprises hardware 102 (which will be further discussed with reference to FIGS. 3 and 4). Application 104 may be any application program to be executed on the processing system. In various embodiments, the application program may be a standalone program for performing any function, or a part of another program (such as a plug-in, for example), for a web browser, image processing application, game, or multimedia application, for example. Operating system (OS) 106 interacts with application 104 and hardware 102 to control the operation of the processing system as is well known. OS 106 comprises a graphical user interface (GUI) 108 to manage the interaction between the user and various input and output devices. Processing system 100 comprises multiple known input and output devices (not shown). Touch screen display 110 may be included in the system to display output data to the user as well as to accept input signals from the user via the touch screen. In an embodiment, the OS may include a display manager component 112 to manage the input data from and the output data to the touch screen display 110. In another embodiment, the processing system may replace or augment the touch screen display with a mechanism for detecting gestures of the user in three dimensional space.

In an embodiment, GUI 108 comprises user input control component 116 to analyze the gestural input data received from the touch screen display. User input control component 116 may receive gestural input data, either directly or indirectly, from touch screen display 110 via display manager 112. In an embodiment, user input control component 116 affects the display of information on the touch screen display depending on how the user is using the processing system. In an embodiment, user input control component 116 overrides sensed input data relating to a user's gesture with an inferred gesture based on the user's past behavior with the processing system.

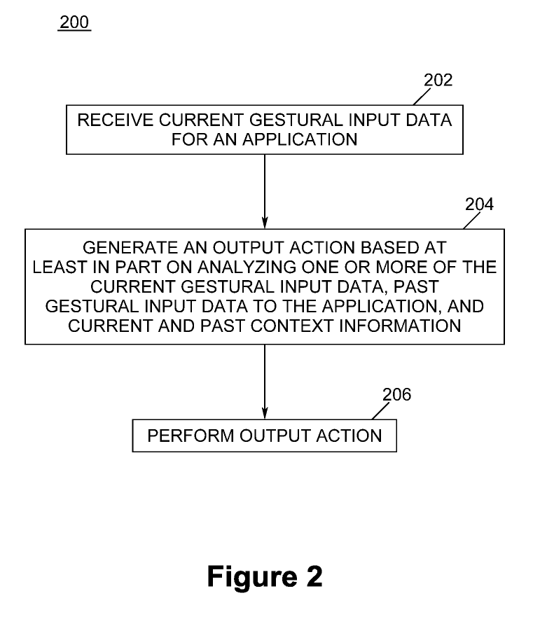

FIG. 2 is a flow diagram of gesture recognition processing 200 according to an embodiment of the present invention. At block 202, current gestural input data may be received for an application 104 by user input control component 116. The current gestural input data may comprise a series of sensed touch points on the touch screen over time along with time stamps of when the touch points were sensed. In response to receiving and processing the gestural input data, an output action may be generated. At block 204, the user input control component may generate the output action based at least in part on analyzing one or more of the current gestural input data to the application, past gestural input data to the application that has been stored by the user input control component, and current and past context information of the processing system. In an embodiment, the context information may comprise, for example, such items as the current time of day, the current time zone, the geographic location of the processing system, the applications active on the processing system, and the current status of the user in a calendar application (e.g., available, in a meeting, out of the office, on vacation, etc.). The past and/or current context information may also include other items.

Based on this analysis, the processing system may perform the output action at block 206. In one embodiment, the output action may comprise displaying output data on the touch screen display 110 (including one or more of displaying a still image or icon, and/or a video). In another embodiment, the output action may comprise producing an audible sound. In another embodiment, the output action may comprise generating a vibration of the processing system. In embodiments of the present invention, the output action performed according to the received gestural input data may be inferred as the current navigational intent of the user based at least in part on previous gestural inputs to the application and the context.

In an embodiment, at least one of the processing steps of FIG. 2 may be implemented by user input control component 116 of the GUI 108.

Some non-limiting example use cases may illustrate the types of user interactions that may be accomplished using embodiments of the present invention. In one example, the user wishes to set an alarm using an alarm application on the processing system in order to wake up in the morning at the usual time. In prior art processing systems, the user needs to use the touch screen display to scroll through the display of up to 60 numbers (values for the minute) and up to 12 or 24 numbers (values for the hour) separately to set the alarm time. In an embodiment of the present invention, the alarm application can add accuracy to the user's scrolling behavior via the user input control component by gently snapping to the hours and minutes that were most frequently used as alarms over a past period of time (such as a month, for example). This allows the user to set the time with two general gestural user input actions (one for hour, one for minute) as opposed to carefully scrolling up and down each of the hour and minute scroll wheels to specifically find the desired hour and minute.

In another example, the user uses a web browser to log in to a web-based email account on the processing system. In an embodiment, the processing system may have a display of a relatively limited size (such as on a smart phone, for example). The web page for the email application loads, but the user initially only typically sees the top left portion of the email login page on the display. The user typically needs to pan the display to the bottom-right using the touch screen display to see the login panel for the email web page. The user pans the page by gesturing a few times to the right and to the bottom to bring the login panel into view on the display.

After capturing that the user typically carries on this particular navigation sequence as the first action when accessing the email web site login page, in an embodiment of the present invention, the user input control component may adapt or customize the navigation behavior for this particular web page by the web browser application. If the user gestures in the bottom-right direction on this particular web page, the panning mechanism in the browser overrides the velocity and inertia detected by touch screen and display manager of the processing system, and gently snaps to display the desired login panel area directly. As a result, the user gets to the content that the user is interested in with a single, imprecise gesture, as opposed to a series of calculated and precise panning gestures.

In a third example, having a growing number of contacts results in a long list of entries in address book applications. To initiate a conversation, the user needs to scroll and find a particular user among perhaps hundreds of entries. Instead of requiring precise scrolling to find a contact, in embodiments of the present invention, a list UI widget of the address book application may exchange usage data with other applications to help the user quickly and easily locate a person of interest in the long list. For example, the address book application may change the speed of scrolling to gently snap directly to contacts who meet one or more of the following criteria, for example: a) people who have contacted the user recently; b) people who have been contacted by the user recently; c) people who are contacted back and forth frequently; d) users who have been declared under a group of interest (family, work friends etc) locally or on a cloud-based service; e) people who have recently commented on this user on a social networking site; f) people who are currently in the vicinity of the user; and g) people who are invitees to the same activity as the user.

FIG. 3 is a diagram of a user input control component 116 according to an embodiment of the present invention. In an embodiment, display manager 112 may include a gesture recognition engine 302. In another embodiment, the gesture recognition engine may be separate from the display manager but communicatively coupled to the display manager. The gesture recognition engine 302 takes raw input data according to sensed touches of the user by the touch screen and detects one or more gestures from the raw input data. The resulting gestural input data may describe information about one or more of spatial location, planar location, inertia, speed, distance, and time. User input control component 116 comprises one or more reporting widgets 304. In an embodiment, there may be a reporting widget active for each application active on the processing system. Upon detecting a gestural input, the gesture recognition engine forwards the gestural input data to one or more of the reporting widgets.

Each reporting widget that receives gestural input data may send the gestural input data to one or more aggregators 306. An aggregator analyzes received gestural input data, stores the gestural input data, and looks for patterns of interest. In an embodiment, there may be multiple aggregators, with each aggregator being configured to train on specified aspects of the user's gestural input behavior. As a result of the training, the aggregator creates and/or updates a usage model describing the user's gestural input behavior and stores this information.

In an embodiment, an aggregator 306 may create and/or update a UI control application specific usage model and store the application specific usage model in one of a plurality of UI control application databases 308. A UI control application specific usage model may comprise a description of how the user has previously interacted through gestures with a specific application executing on the processing system. The application specific usage model may include past user gestures with the specific application. In an embodiment, there may be one usage model and one UI control application database for each application for each user of the processing system.

In an embodiment, context trainer 307 may create and/or update a UI control context usage model and store the context usage model in a UI control context database 312. The context usage model may comprise a description of the context in which the user has previously interacted with the processing system using gestures. For example, context might include, for example, such items as the geographic location, calendar status, time of day, a list of active applications, and so on.

Once the usage models are stored in the respective databases, this history information may be used to predict the user's current navigational intent based on the past behavior of the user. The usage models may specify the frequency, probability, and extent of user behavior and/or certain triggers. User input control component 116 includes an application specific predictor 310 and a context predictor 314. Application specific predictor 310 uses the application specific usage model relevant to the application currently being interacted with by the user and the current gestural input data to determine whether the current gestural input should be overridden with predicted values. Context predictor 314 uses the context usage model, the current context, and the current gestural input data to determine whether the current gestural input should be overridden with predicted values.

The predicted values, if any, may be combined in a predetermined priority manner by modifying widget 316. Modifying widget may modify the gestural input data as directed by one or both of the predictors, and pass the modified gestural input data to display manager 112 for display of the modified user's gesture. If no modification is specified, then modifying widget 316 passes the unmodified gestural input data to display manager 112 for display of the unmodified user's gesture.

FIG. 4 is a flow diagram 400 of a user input control processing according to an embodiment of the present invention. In an embodiment, at least one of the processing steps of FIG. 4 may be implemented by user input control component 116 of the GUI 108. At block 402, a reporting widget 304 may receive gestural input data from gesture recognition engine 302. A block 404, the reporting widget sends the gestural input data to one or more aggregators 306. At block 406, each aggregator may create and/or update an application specific usage model based at least in part on an analysis of the current gestural input data and past gestural input data of the user. At block 408, context trainer 307 may create and/or update a context usage model based at least in part on the current context of the processing system. In one embodiment, blocks 402, 404, 406, and 408 may be performed concurrently.

At block 410, application specific predictor 310 and context predictor 314 predict modifications, if any, to the gestural input data based at least in part on the current gestural input data, the usage models, and the current context. At block 412, a determination is made whether to modify the gestural input data. If yes, at block 414 modifying widget 316 modifies and forwards the gestural input data to display manager 112. If no, at block 416 modifying widget forwards the unmodified gestural input data to the display manager.

When the gestural input data is modified according to the usage models, an improved user interface (including better scrolling behavior) may be provided to the user of a touch screen display in a processing system.

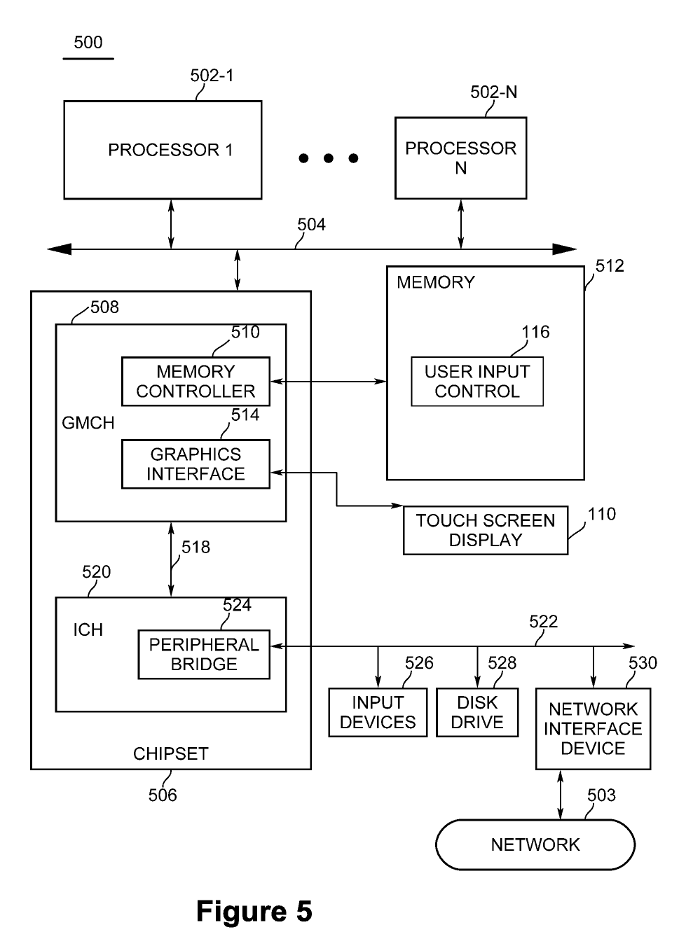

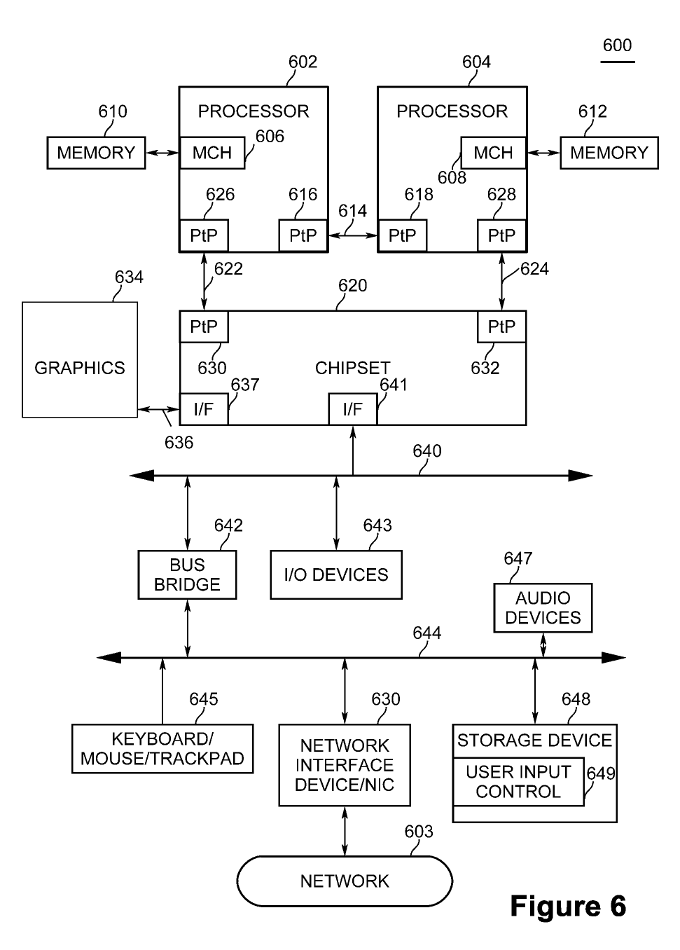

FIG. 5 illustrates a block diagram of an embodiment of a processing system 500. In various embodiments, one or more of the components of the system 500 may be provided in various electronic devices capable of performing one or more of the operations discussed herein with reference to some embodiments of the invention. For example, one or more of the components of the system 500 may be used to perform the operations discussed with reference to FIGS. 1-4, e.g., by processing instructions, executing subroutines, etc. in accordance with the operations discussed herein. Also, various storage devices discussed herein (e.g., with reference to FIG. 5 and/or FIG. 6) may be used to store data, operation results, etc. In one embodiment, data may be received over the network 503 (e.g., via network interface devices 530 and/or 630) may be stored in caches (e.g., L1 caches in an embodiment) present in processors 502 (and/or 602 of FIG. 6). These processors may then apply the operations discussed herein in accordance with various embodiments of the invention.

More particularly, the processing system 500 may include one or more central processing unit(s) 502 or processors that communicate via an interconnection network (or bus) 504. Hence, various operations discussed herein may be performed by a processor in some embodiments. Moreover, the processors 502 may include a general purpose processor, a network processor (that processes data communicated over a computer network 503, or other types of a processor (including a reduced instruction set computer (RISC) processor or a complex instruction set computer (CISC)). Moreover, the processors 502 may have a single or multiple core design. The processors 502 with a multiple core design may integrate different types of processor cores on the same integrated circuit (IC) die. Also, the processors 502 with a multiple core design may be implemented as symmetrical or asymmetrical multiprocessors. Moreover, the operations discussed with reference to FIGS. 1-4 may be performed by one or more components of the system 500. In an embodiment, a processor (such as processor 1 502-1) may comprise user input control 116, GUI 108, and OS 106 as hardwired logic (e.g., circuitry) or microcode.

A chipset 506 may also communicate with the interconnection network 504. The chipset 506 may include a graphics and memory control hub (GMCH) 508. The GMCH 508 may include a memory controller 510 that communicates with a memory 512. The memory 512 may store data and/or instructions. The data may include sequences of instructions that are executed by the processor 502 or any other device included in the processing system 500. Furthermore, memory 512 may store one or more of the programs or algorithms discussed herein such as user input control 116, GUI 108, and OS 106, instructions corresponding to executables, mappings, etc. The same or at least a portion of this data (including instructions, and temporary storage arrays) may be stored in disk drive 528 and/or one or more caches within processors 502. In one embodiment of the invention, the memory 512 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 504, such as multiple processors and/or multiple system memories.

The GMCH 508 may also include a graphics interface 514 that communicates with touch screen display 110. In one embodiment of the invention, the graphics interface 514 may communicate with the touch screen display 110 via an accelerated graphics port (AGP). In an embodiment of the invention, the display 110 may be a flat panel display that communicates with the graphics interface 514 through, for example, a signal converter that translates a digital representation of an image stored in a storage device such as video memory or system memory into display signals that are interpreted and displayed by the display 110. The display signals produced by the interface 514 may pass through various control devices before being interpreted by and subsequently displayed on the display 110. In an embodiment, user input control 116 may be implemented as circuitry within graphics interface 514 or elsewhere within the chipset.

A hub interface 518 may allow the GMCH 508 and an input/output (I/O) control hub (ICH) 520 to communicate. The ICH 520 may provide an interface to I/O devices that communicate with the processing system 500. The ICH 520 may communicate with a bus 522 through a peripheral bridge (or controller) 524, such as a peripheral component interconnect (PCI) bridge, a universal serial bus (USB) controller, or other types of peripheral bridges or controllers. The bridge 524 may provide a data path between the processor 502 and peripheral devices. Other types of topologies may be utilized. Also, multiple buses may communicate with the ICH 520, e.g., through multiple bridges or controllers. Moreover, other peripherals in communication with the ICH 520 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 522 may communicate with input devices 526 (such as a track pad, mouse, or other pointing input device, or touch screen display 110), one or more disk drive(s) 528, and a network interface device 530, which may be in communication with the computer network 503 (such as the Internet, for example). In an embodiment, the device 530 may be a network interface controller (NIC) capable of wired or wireless communication. Other devices may communicate via the bus 522. Also, various components (such as the network interface device 530) may communicate with the GMCH 508 in some embodiments of the invention. In addition, the processor 502, the GMCH 508, and/or the graphics interface 514 may be combined to form a single chip.

Furthermore, the processing system 500 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 528), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

In an embodiment, components of the system 500 may be arranged in a point-to-point (PtP) configuration such as discussed with reference to FIG. 6. For example, processors, memory, and/or input/output devices may be interconnected by a number of point-to-point interfaces.

More specifically, FIG. 6 illustrates a processing system 600 that is arranged in a point-to-point (PtP) configuration, according to an embodiment of the invention. In particular, FIG. 6 shows a system where processors, memory, and input/output devices are interconnected by a number of point-to-point interfaces. The operations discussed with reference to FIGS. 1-4 may be performed by one or more components of the system 600.

As illustrated in FIG. 6, the system 600 may include multiple processors, of which only two, processors 602 and 604 are shown for clarity. The processors 602 and 604 may each include a local memory controller hub (MCH) 606 and 608 (which may be the same or similar to the GMCH 508 of FIG. 5 in some embodiments) to couple with memories 610 and 612. The memories 610 and/or 612 may store various data such as those discussed with reference to the memory 512 of FIG. 5.

The processors 602 and 604 may be any suitable processor such as those discussed with reference to processors 502 of FIG. 5. The processors 602 and 604 may exchange data via a point-to-point (PtP) interface 614 using PtP interface circuits 616 and 618, respectively. The processors 602 and 604 may each exchange data with a chipset 620 via individual PtP interfaces 622 and 624 using point to point interface circuits 626, 628, 630, and 632. The chipset 620 may also exchange data with a high-performance graphics circuit 634 via a high-performance graphics interface 636, using a PtP interface circuit 637. Graphics 624 may be coupled with a touch screen display 110 (not shown in FIG. 6).

At least one embodiment of the invention may be provided by utilizing the processors 602 and 604. For example, the processors 602 and/or 604 may perform one or more of the operations of FIGS. 1-4. Other embodiments of the invention, however, may exist in other circuits, logic units, or devices within the system 600 of FIG. 6. Furthermore, other embodiments of the invention may be distributed throughout several circuits, logic units, or devices illustrated in FIG. 6.

The chipset 620 may be coupled to a bus 640 using a PtP interface circuit 641. The bus 640 may have one or more devices coupled to it, such as a bus bridge 642 and I/O devices 643. Via a bus 644, the bus bridge 643 may be coupled to other devices such as a keyboard/mouse/track pad 645, the network interface device 630 discussed with reference to FIG. 5 (such as modems, network interface cards (NICs), or the like that may be coupled to the computer network 503), audio I/O device 647, and/or a data storage device 648. The data storage device 648 may store, in an embodiment, user input control instructions 649 that may be executed by the processors 602 and/or 604.

In various embodiments of the invention, the operations discussed herein, e.g., with reference to FIGS. 1-4, may be implemented as hardware (e.g., logic circuitry), software (including, for example, micro-code that controls the operations of a processor such as the processors discussed with reference to FIGS. 5 and 6), firmware, or combinations thereof, which may be provided as a computer program product, e.g., including a tangible machine-readable or computer-readable medium having stored thereon instructions (or software procedures) used to program a computer (e.g., a processor or other logic of a computing device) to perform an operation discussed herein. The machine-readable medium may include a storage device such as those discussed herein.

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Additionally, such computer-readable media may be downloaded as a computer program product, wherein the program may be transferred from a remote computer (e.g., a server) to a requesting computer (e.g., a client) by way of data signals, via a communication link (e.g., a bus, a modem, or a network connection).

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

1. In a processing system having a touch screen display, a method of inferring navigational intent by a user in a gestural input system of the processing system comprising:
receiving current gestural input data for an application of the processing system from the touch screen display;
generating an output action based at least in part on an analysis of one or more of the current gestural input data, past gestural input data for the application, and current and past context information of usage of the processing system; and
performing the output action.

2. The method of claim 1, wherein the current and past context information comprises at least one of current time of day, current time zone, geographic location of the processing system, other applications active on the processing system, and current status of the user in a calendar application.

3. A machine-readable medium comprising one or more instructions that when executed on a processor of a processing system, the processing system including a touch screen display, to perform one or more operations to receive current gestural input data for an application of the processing system from the touch screen display, and to generate an output action based at least in part on an analysis of one or more of the current gestural input data, past gestural input data for the application, and current and past context information of usage of the processing system.

4. The machine-readable medium of claim 4, wherein the current and past context information comprises at least one of current time of day, current time zone, geographic location of the processing system, other applications active on the processing system, and current status of the user in a calendar application.

5. A processing system comprising:
a touch screen display; and
a graphical user interface to infer navigational intent by a user when providing gestural input data to the touch screen display, the graphical user interface adapted to receive current gestural input data for an application of the processing system from the touch screen display, and to generate an output action based at least in part on an analysis of one or more of the current gestural input data, past gestural input data for the application, and current and past context information of usage of the processing system.

6. The processing system of claim 5, wherein the current and past context information comprises at least one of current time of day, current time zone, geographic location of the processing system, other applications active on the processing system, and current status of the user in a calendar application.

7. In a processing system having a touch screen display, a method of inferring navigational intent by a user in a gestural input system of the processing system comprising:
receiving current gestural input data for an application of the processing system from the touch screen display;
sending the current gestural input data to at least one aggregator component;
at least one of creating and updating an application specific usage model by the at least one aggregator component based at least in part on the current gestural input data, past gestural input data, and the application;
at least one of creating and updating a context usage model based at least in part on a current context of the processing system;
predicting modifications to the current gestural input data based at least in part one or more of the current gestural input data, the current context, the application specific usage model, and the context usage model; and
modifying the current gestural input data based at least in part on the predicted modifications.

8. The method of claim 7, further comprising performing an output action based at least in part on the modified current gestural input data.

9. The method of claim 8, wherein performing an output action based at least in part on the modified current gestural input data comprising providing improved scrolling behavior for a graphical user interface of the processing system.

10. A processing system comprising:
a touch screen display;
at least one reporting component to receive current gestural input data by a user from the touch screen display for use by an application;
at least one aggregator component to receive current gestural input data from the at least one reporting component, to analyze the current gestural input data in relation to past gestural input data, and to at least one of create and update an application specific usage model;
a context trainer component to at least one of create and update a context usage model based at least in part on a current context of the processing system;
an application specific predictor component to predict the user's current navigational intent for gestural input based at least in part on the current gestural input data and the application specific usage model;
a context predictor component to predict the user's current navigational intent for gestural input based at least in part on the current gestural input data and the context usage model; and
a modifying component to modify the current gestural input data based at least in part on the predicted values from at least one of the application specific predictor component and the context predictor component.

11. The processing system of claim 10, further comprising one reporting component for each application active on the processing system.

12. The processing system of claim 11, wherein the application specific usage model comprises a description of how the user has previously interacted through gestures with the application.

13. The processing system of claim 11, wherein the context usage model comprises a description of the context in which the user has previously interacted with the processing system using gestures.

14. The processing system of claim 13, where the context comprises at least one of geographic location of the processing system, calendar status, time of day, and a list of active applications.

15. The processing system of claim 11, comprising one application specific usage model for each application for each user of the processing system.

16. The processing system of claim 11, further comprising performing an output action resulting from the modified current gestural input data.
